(19) United States
(12) Patent Application Publication
(10) Pub. No.: US 2020/0202284 A1
(43) Pub. Date: Jun. 25, 2020

(54) SYSTEMS, METHODS, AND DEVICES FOR ITEM DELIVERY USING UNMANNED AERIAL VEHICLES

(71) Applicant: Ford Global Technologies, LLC, Dearborn, MI (US)

(72) Inventors: Aditya Singh, Redwood City, CA (US); James Carthew, Oakland, CA (US)

(73) Assignee: Ford Global Technologies, LLC, Dearborn, MI (US)

(21) Appl. No.: 16/230,401

(22) Filed: Dec. 21, 2018

(51) Int. Cl. G06Q 10/08; G06Q 20/20; B64C 39/02; G05D 1/10; H04L 9/32

(52) U.S. Cl. CPC G06Q 10/083; G06Q 20/20; B64C 39/024; B64C 2201/141; H04L 9/3213; B64C 2201/128; B64C 2201/108; G05D 1/101

(57) ABSTRACT

Systems and methods are disclosed for item delivery using unmanned aerial vehicles. Example methods may include receiving, by a management component communicatively coupled to at least one processor via a transceiver, instructions for a UAV, wherein the instructions include a delivery request for one or more items; determining, via a routing component, a predetermined route based on the delivery request, wherein the predetermined route maximizing a visibility of the UAV by one or more users; and accepting, by a payment component communicatively coupled to the at least one processor and at least one memory, payment for the one or more items from one or more users.

### TECHNICAL FIELD

The disclosure relates generally to unmanned aerial vehicles (UAVs) or drones and more particularly relates to systems, methods, and devices for item delivery using UAVs.

### BACKGROUND

An increasing number of packages are delivered to business, residential, and other locations daily. Package delivery of small quantities of items is often completed using a delivery truck, van, or other vehicle that is driven by a human driver. The human may drive the vehicle between delivery locations and walk with a package up to or into a building, mailbox, or other location to deliver the package. In some embodiments, unmanned aerial vehicles (UAVs) (also referred to as drones herein) may be used in a growing body of applications, including faster and cheaper package delivery.

### BRIEF DESCRIPTION OF THE DRAWINGS

FIG. 1A shows an example environment in which UAVs may operate, in accordance with example embodiments of the disclosure.

FIG. 1B shows an example use case involving the UAVs described herein, in accordance with example embodiments of the disclosure.

FIG. 2A shows a diagram that depicts an example UAV, in accordance with example embodiments of the disclosure.

FIG. 2B shows a diagram of an example compartment that may be used in connection with a UAV, in accordance with example embodiments of the disclosure.

FIG. 3 illustrates a set of components that may be associated with a UAV, according to various embodiments of the disclosure.

FIG. 4A illustrates a set of components associated with a mobile device including a UAV application, according to various embodiments of the disclosure.

FIG. 4B shows a diagram of a process flow for item delivery, in accordance with example embodiments of the disclosure.

FIG. 5 shows a diagram of an exemplary payment system associated with the UAV including a cryptocurrency payment network, in accordance with example embodiments of the disclosure.

FIG. 6 shows a diagram illustrating a blockchain, in accordance with example embodiments of the disclosure.

FIG. 7 is a functional diagram illustrating details of each block and transaction in the blockchain of FIG. 6, in accordance with example embodiments of the disclosure.

FIG. 8 shows a diagram of a process flow for package delivery using UAVs, in accordance with example embodiments of the disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In some embodiments, unmanned aerial vehicles (UAVs) (also referred to as drones herein) may be used in a growing body of applications, including faster and cheaper package delivery. In various embodiments, UAVs may provide a platform for mobile commerce. For example, UAVs may serve as couriers for packages, and such UAVs may require users (e.g., customers) to pre-order various items, prepay for the items, and await the item's arrival via the UAV. In various embodiments, such UAV delivery services may have certain limitations. For example, services may exclude customers from utilizing UAV delivery services if they are wary of submitting payment information (e.g., credit card details, personal details, combinations thereof, and/or the like) via one or more public networks (e.g., WiFi, cellular, Internet, combinations thereof, and/or the like). In another embodiment, such services may be used for the delivery of pre-ordered items and may be feasible if the users are located in relative proximity to a facility (e.g., a warehouse in which the items can be stored). Alternatively or additionally, such services may be used for delivery of pre-ordered items if the delivery service may use mobile facilities (e.g., delivery trucks) in conjunction with the UAVs to deliver the items. Accordingly, the use of such UAVs under such contextual constraints may serve to reduce the ability of the UAV services to support customer impulse purchases of goods.

In various embodiments, disclosed herein are systems, methods, and apparatuses that are directed to UAV's having point-of-sale (POS) capabilities to facilitate purchases of items by one or more users. In one embodiment, the UAVs may use the POS systems and apparatuses to allow for quicker payment. For example, such POS systems may include, but are not be limited to, electronic funds transfer at point of sale (EFTPOS) credit and debit card systems. In another embodiment, the POS system may include a company-based proprietary system that includes one or more company-based tokens and/or cryptocurrencies that may be used, for example, in connection with a private network, such as a private blockchain network.

In various embodiments, the disclosure may serve to broaden and/or extend the number of potential users (e.g., customers) that can use UAV delivery services. In one embodiment, embodiments of the disclosure may enable a UAV to accept payment directly at the UAV itself (e.g., upon delivery of an item). This may allow users that are wary of submitting payment information online to pay for and use UAV delivery services. In another embodiment, a payment component (e.g., a POS system) may be coupled to the UAV to permit the UAV to accept payments. In further aspects, the payments may include a cryptocurrency or a company-based token.

In one aspect, embodiments of the disclosure may enable a UAV to be summoned by one or more users, which may serve to extend the variety of business experiences available to users. For example, the UAVs may be used to offer one or more concessionary and/or vending services. In another example, the UAVs may be used to cater to impulse purchases, as will be further described herein.

In some embodiments, certain UAVs (e.g., UAVs having a predetermined size and/or weight) may be permitted (e.g., by governing bodies) to fly over groups of users. Accordingly, in certain scenarios (e.g., ticketed events, employee events, concerts, gatherings, political rallies, combinations thereof, and/or the like) a UAV may be flown over a crowd of users. In one embodiment, the UAVs may be crowd safe in that the UAVs may be light weight and may have propeller guarding mechanisms (e.g., cages and the like) that may prevent people and/or objects from coming into direct contact with the propellers of the UAVs. In one embodiment, such a solution may enable a UAV to be operated, for example, as a concessionaire. For example, the UAV may include one or more items in a cargo component of the UAV and may be summoned by one or more users. By having the ability to accept payment directly at the user's location as described, the UAV may be better able to cater to one or more impulse purchases by the users.

In one embodiment, the UAVs may be loaded with items having a high likelihood of purchase, for example, as determined by numerous factors, individually or in combination, such as historical data, current trending data, social media posts, one or more user profiles, and the like. Further, one or more machine learning (ML) algorithms may be used to process the said data and determine which items have a higher likelihood of being purchased. Further, the UAVs may be directed to populated regions, where the UAVs may be configured to fly in predetermined routes that seek to maximize visible coverage to potential users (e.g., customers). In another embodiment, the users may use a user device (e.g., a mobile phone) to call for a UAV (e.g., a UAV that the users see or detect via their user device) and then, the users may purchase items that the UAV is transporting. In another embodiment, the purchase of the item(s) may be performed in a similar fashion as the purchase of items from a vending machine. In various embodiments, the UAVs may be configured to display items and/or ads about such items, or may be configured to transmit information to user devices (e.g., user devices that are proximate to the UAVs) indicative of purchasable items. This display of information and/or advertisements (including, but not limited to, the display of information on the UAV itself or one or more user devices) may encourage users to buy the items. In one embodiment, the environment in which the UAV is in (e.g., a stadium or a concert) may be configured to display information received from the UAV or other third-party devices, the information indicative of purchasable items from the UAV(s) proximate to the environment. For example, a baseball stadium may display advertisements and/or other information associated with the UAVs that may inform users in the stadium to order concessions using the UAVs.

In one embodiment, the UAV may be used in connection with a restocking area. In particular, the restocking area may include a static building (e.g., a warehouse or similar structure). In another embodiment, the restocking area may include a mobile component (e.g., a truck or similar), which may be within a predetermined distance of an environment that the UAV is used in (e.g., a concert, a gathering, and/or the like).

In one embodiment, a user may provide instructions to a UAV indicative of a delivery order, using a mobile application on a user device (e.g., a mobile phone). In particular, the application may be configured to transmit a signal to a transceiver of a nearby UAV (e.g., a UAV within a predetermined distance from the user device) to approach the user and to land/hover in order to allow the user to purchase and receive the item.

In various embodiments, the UAV may include a cargo component. In another embodiment, the cargo component may be transparent, for example, to allow users to see the types of products that the UAV offers for sale. In another embodiment, the UAV may have a cargo component that may be lockable and may be unlocked after the user makes a purchase of an item. In another embodiment, the UAV may include an interface (e.g., a touch screen) to enable user interaction. Further, the UAV may include a payment component, for example, an electronic funds transfer at point of sale (EFTPOS) device. The EFTPOS device may be capable of executing a transaction (e.g., an electronic fund transaction) using one or more of a magnetic strip, chip, and near field communication (NFC) device. In another embodiment, a wireless communication device can allow for the payment component to receive payment confirmations.

In one embodiment, if payment is confirmed via the payment component of the UAV, the cargo compartment may dispense the item to the user. In various embodiments, a single UAV may be equipped with multiple cargo compartments for carrying a range of items (e.g., commonly purchased items). In another embodiment, this may reduce the number of UAVs needed to serve an area without compromising inventory options. In another embodiment, when a UAV sells out of a given item or a given type of item, the UAV may return to the restocking area; otherwise, the UAV may be configured to continue to scan for additional potential customers.

In various embodiments, the restocking area may include an area in which the concessionaire UAV can land and undergo operational maintenance. In various embodiments, operational maintenance may include, but not be limited to, item restocking and battery replacement and/or charging, fixing other components of the UAV, combinations thereof, and/or the like. In one embodiment, the restocking of the UAV with items may be performed manually by a human operator or may be automated via a UAV management component. In various embodiments, the restocking area can be a static building with battery charging and stock warehousing capabilities. In another embodiment, the restocking area may include a mobile component. For example, for use in connection with events in remote locations the restocking area can include a truck or van with a UAV management component.

In another embodiment, one or more UAVs may be geo-locked to a particular event location or UAV service area within an event location for a given duration of time. In another embodiment, if the UAV exits the region of the geo-lock, the UAV may alert an alarm to one or more entities (e.g., law enforcement, companies, security services, insurance companies, combinations thereof, and/or the like).

In various embodiments, the UAV may hold one type of product (e.g., food items such as chips of a particular brand, or beverages of a particular type). In another embodiment, the UAV may hold a plurality of items of different type (e.g., a food item, a personal hygiene item, a clothing item, and the like).

In one embodiment, embodiments of the disclosure may be used in connection with food trucks, ice cream truck vendors, and the like, enabling such vendors to reach more customers by using the UAVs described herein.

In another embodiment, if one or more UAVs are stolen or damaged, one or more security components including, but not limited to, sirens, dye bombs, and/or cloud-enabled cameras that may record the scene of the crime may be engaged. Such devices may provide additional theft/vandalism deterrence and may further provide a means to identify transgressors. In one embodiment, the security components (e.g., sirens, dye bombs, and the like) may be triggered to activate if the UAV travels more than a predetermined distance from a landmark (e.g., an event center, a stadium, a food truck location, and/or the like).

Embodiments of the disclosure provide users a means to purchase UAV-deliverable items without submitting their payment and/or personal information online. In another aspect, embodiments of the disclosure enable users to purchase items from UAVs without prepayment. Alternatively or additionally, users may purchase items using payment applications on a user device (e.g., a mobile phone). Further embodiments of the disclosure provide users with the opportunity to make impulse purchases of items as advertised or displayed by UAVs. Moreover, embodiments of the disclosure provide a means for distributing items (e.g., concessions, medical supplies, and/or the like) at relatively large events (e.g., concerts, rallies, and/or the like), where there may be natural bottlenecks that prevent the ease of distributing the items by conventional means (e.g., waiters, bartenders, vending machines, and/or the like).

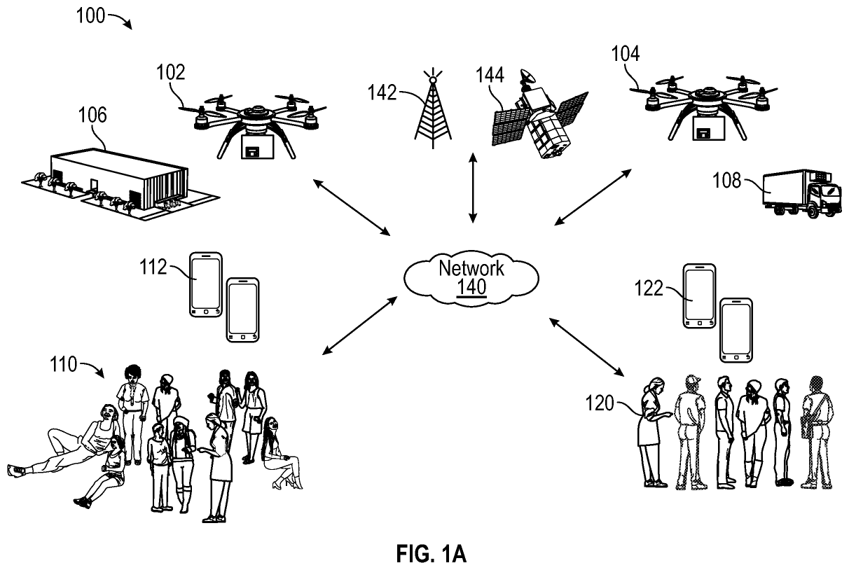

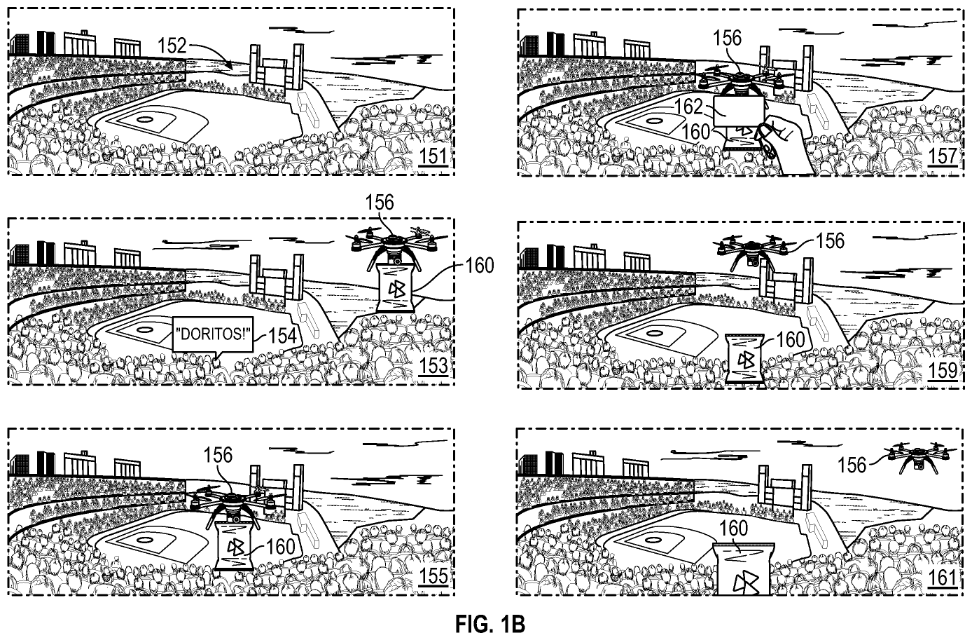

FIG. 1A shows an example environment in which the UAVs may operate, in accordance with example embodiments of the disclosure. In particular, FIG. 1 shows an environment 100 and shows a first UAV 102 and a second UAV 104. The UAVs 102 and 104 may be merely representative UAVs in environment 100, which may include anywhere from 10s to hundreds or thousands of UAVs.

In some embodiments, UAV 102 may be associated with first restocking station 106, while UAV 104 may be associated with second restocking station 108. In one embodiment, the first restocking station 106 may be fixed in location, while the second restocking station 108 may be mobile. In some aspects, a plurality of mobile restocking stations such as second restocking station 108 may be arranged strategically to cover a given geographical area for a given period of time. For example, during periods of high demand for packages (e.g., during holiday seasons, during disaster relief operations, etc.), several mobile restocking stations may be arranged in a given pattern in a city or county to most efficiently distribute the packages to different sites for a period of time, such as for a day, a week, or longer. In another aspect, the restocking stations may include a charging unit (e.g., a battery) for charging the UAV. The charging unit may be configured to wirelessly charge the UAV.

In another aspect, the first restocking station 106 can include a ground-based distribution center. In another aspect, the distribution center may include a warehouse or other specialized building, often with refrigeration or air conditioning, which may be stocked with products (goods) to be redistributed to other distribution centers, retailers, wholesalers, or directly to consumers. In one aspect, a distribution center can also be referred to as a warehouse, a fulfillment center, a cross-dock facility, a bulk break center, and/or a package handling center. In one aspect, the name of the distribution center may be based on the purpose of the operation. For example, a retail distribution center may distribute goods to retail stores, an order fulfillment center may distribute goods directly to consumers, and a cross-dock facility may distribute goods to other destination. In one aspect, the distribution center may range in size from less than approximately 50,000 square feet (5,000 square meters) to approximately 3 million square feet (300,000 square meters).

In another aspect, the distribution center may include three main areas and additional specialized areas. In one aspect, the three main areas may include a receiving area or dock, a storage area, and a shipping area or dock. In smaller ground components, it may be possible for the receiving and shipping functions to occur side by side. In another aspect, the receiving dock can also be specialized based on the handling characteristics of freight being received, on whether the product is going into storage or directly to a store, or by a type of vehicle delivering the product.

As noted, the second restocking station 108 may include a mobile component (e.g., a vehicle such as a truck). In particular, the type of vehicle may include a specialized vehicle to deliver a particular type of product. For example, the mobile restocking station may include semi-trailers that are outfitted with various trailers such as box trailers, flatbeds, car carriers, tanks and other specialized trailers. The mobile restocking station may further include armored cars, dump trucks and concrete mixers. In one aspect, the mobile restocking station may include passenger vehicles that may be used for delivery of goods. Non-limiting examples include buses, vans, pick-ups, and cars (e.g., for mail or pizza delivery).

In various embodiments, the UAVs 102 and/or 104 may include vehicles that are capable of flight and/or navigation with little or no real-time human input. For example, embodiments of UAVs may deliver packages from restocking stations 106 and/or 108 to a delivery location with little or no input from a local or remote human operator. However, it will be appreciated that embodiments of UAVs disclosed herein may also deliver packages from a restocking station to a delivery location and/or user with some input from a local or remote human operator.

In various embodiments, the first UAV 102 may be configured to be associated with first portion 110 of a group of users, while the second UAV 104 may be associated with a second portion 120 of the group of users in the environment 100. In another embodiment, the first portion 110 of the group of users may have one or more user devices 112. In one embodiment, the second portion 120 of the group of users may have one or more user devices 122.

In one embodiment, a user of the first portion 110 or second portion 120 of the group of users may have user devices 112 and/or 122 (e.g., mobile devices, tablets, laptops, and the like). In one embodiment, a user device of user devices 112 and/or 122 (or more generally a “user device” or “user computing device” as used variously herein) may refer to a computing device that is associated with a user. In some embodiments, the user computing device can be used to communicate with another device, computer, or system. In particular, the user devices 112 and/or 122 can include a user computing device that is used to conduct a transaction. The user device may be capable of conducting communications over a network. The user devices 112 and/or 122 may be in any suitable form. For example, suitable user computing devices can be hand-held and compact so that it can fit into a user's wallet and/or pocket (e.g., pocket-sized). The user device 112 can include a processor, and memory, input devices, and output devices, operatively coupled to the processor. Specific examples of user computing devices include cellular or mobile phones, tablet computers, desktop computers personal digital assistants (PDAs), pagers, portable computers, smart cards, and the like. Additional user computing devices may include wearable devices, such as smart watches, glasses fitness bands, ankle bracelets, rings, earrings, etc. In some embodiments, the user computing device may include automobiles with remote communication capabilities.

In various embodiments, the UAVs 102, 104, and other UAVs (not shown) and the user devices 112, 122, and other user devices (not shown) may be connected over any suitable network 140. In various embodiments, the network 140 may include wireless external communication networks using any of a variety of protocols, such as general packet radio service (GPRS), Universal Mobile Telecommunications System (UMTS), Code Division Multiple Access 2000 (CDMA ), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Zigbee, Bluetooth protocols, wireless universal serial bus (USB) protocols, and/or any other wireless protocol.

In various embodiments, one or more satellites similar to satellite 144 and/or one or more cell towers similar to cell tower 142 may be used to locate user devices 112 and/or 122, UAVs 102 and/or 104, and other devices (not shown), for example, devices associated with the first restocking station 106 and/or the second restocking station 108.

In another embodiment, the UAVs 102 and/or 104, the user devices 112 and/or 122 may include a transceiver, which may in turn may include one or more location receivers (e.g., GPS receivers) that may receive location signals (e.g., GPS signals) from one or more satellites 144. In another embodiment, a GPS receiver may refer to a device that can receive information from GPS satellites (e.g., satellites 144) and calculate the geographical position of one or more of the UAVs 102 and/or 104, the user devices 112 and/or 122, using suitable software.

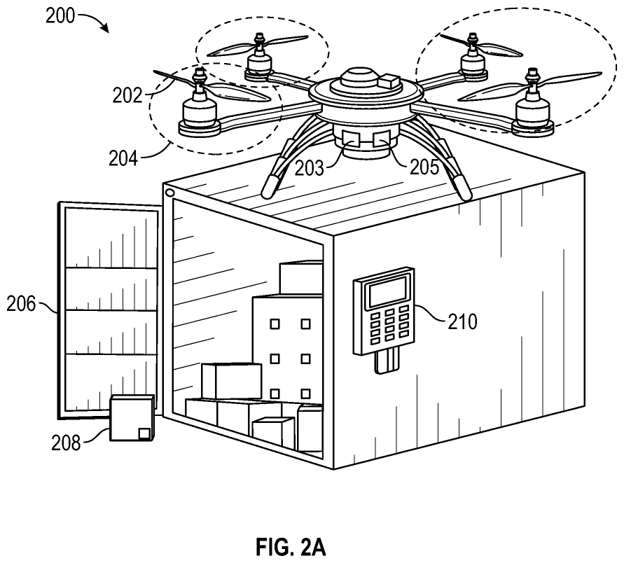

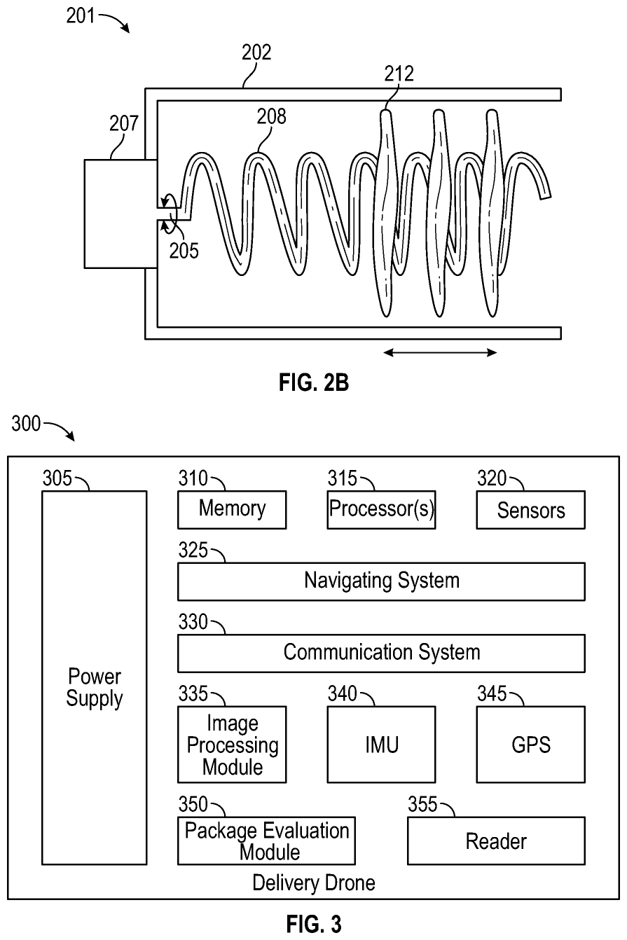

In another embodiment, a given user of the first portion 110 of the group of users may use a user device of the user devices 112 to summon a given UAV using network 140, such as UAV 102. Similarly, in one embodiment, a given user of the second portion 120 of the group of users may use a user device of the user devices 122 to summon a given UAV using network 140, such as UAV 104. Accordingly, UAV 102 may be configured to transport items (e.g., food items) to the user of the first portion 110 of the group of users. Similarly, UAV 104 may be configured to transport items (e.g., food items) to the user of the second portion 120 of the group of users. Further, in the case where the UAV 102 runs out of items or needs a particular item that the UAV 102 is not transporting, the UAV 102 may return to the first restocking station 106 or the second restocking station 108, or other restocking stations (not shown) to retrieve the particular item(s), prior to delivering the item(s) to the user of the first portion 110 of the group of users. Similarly, in the case where the UAV 104 runs out of items or needs a particular item that the UAV 104 is not transporting, the UAV 104 may return to the first restocking station 106 or the second restocking station 108, or other restocking stations (not shown) to retrieve the particular item(s), prior to delivering the item(s) to the user of the first portion 110 or second portion 120 of the group of users. The UAVs 102 and 104 may include payment components (not shown in FIG. 1A, but to be shown and described in connection with FIG. 2A, below) that may be configured to receive payment (e.g., cash, credit, tokens, combinations thereof, and/or the like) from the users of the first portion 110 and the second portion 120 of the group of users.

The user devices 112 and/or 122 may be configured to communicate with each other and/or the one or more devices of the UAVs 102 and/or 104 using one or more communications networks, wirelessly or wired. Any of the communications networks may include, but are not limited to, any one of a combination of different types of suitable communications networks such as, for example, broadcasting networks, public networks (for example, the Internet), private networks, wireless networks, cellular networks, or any other suitable private and/or public networks. Further, any of the communications networks may have any suitable communication range associated therewith and may include, for example, global networks (for example, the Internet), metropolitan area networks (MANs), wide area networks (WANs), local area networks (LANs), or personal area networks (PANs). In addition, any of the communications networks may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

The user devices 112 and/or 122 and/or the UAVs 102 and/or 104 may include one or more communications antennae. Communications antennae may be any suitable type of antenna corresponding to the communications protocols used by the user devices 112 and/or 122 and the devices of the UAVs 102 and/or 104. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user devices 112 and/or 122 and/or UAVs 102 and/or 104.

The user devices 112 and/or 122 may include any suitable radio and/or transceiver for transmitting and/or receiving radio frequency (RF) signals in the bandwidth and/or channels corresponding to the communications protocols utilized by any of the user devices 112 and/or 122 and/or the UAVs' 102 and/or 104 devices to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

FIG. 1B shows diagram associated with an example use case involving the UAVs described herein, in accordance with example embodiments of the disclosure. Diagram 151 shows an example use case in a gaming environment, such as a baseball game 152. In another embodiment, the gaming environment may not be limited to gaming environments, but may include, but not be limited to, concerts, rallies, political events, gatherings, combinations thereof, and/or the like. In another embodiment, environments that may be suitable for operating the disclosed UAVs may include events with relatively large crowds, entertainment, and events that promote impulse purchases of items (e.g., vending items, drinks, and the like).

Diagram 153 depicts a situation where a given user of a group of users (e.g., in a crowd at the baseball game 152) may determine that they want a particular item (e.g., a food item 154). Accordingly, the user may summon a UAV, for example, using a user device (e.g., a mobile phone) via an app. In another embodiment, the user may summon the UAV using by making a gesture (e.g., a hand motion of a predetermined pattern) or by saying a command verbally. The UAV may be configured to detect the gesture or voice command using any suitable technique, including, but not limited to, voice recognition or facial recognition. Such techniques may include Artificial intelligence (AI) based algorithms including machine learning algorithms.

Diagram 155 depicts UAV 156 carrying item 160 (e.g., food item). In particular, the UAV 156 may be configured to scan the crowd and zone in on the user(s) having summoned the UAV. In particular, the UAV 156 may be configured to scan the crowd using one or more cameras of the UAV in association with artificial intelligence (AI)-based algorithms (e.g., computer vision algorithms, neural network algorithms such as convolutional neural networks, and the like) to home in on the user. In various embodiments, flying a UAV in proximity to members of the public may be performed after the firm(s) owning the UAV(s) obtains insurance-based waivers. In various embodiments, the UAV may be designed to prevent injury in the event of a pedestrian collision, as will be shown and described in connection with FIG. 2A, below. In further embodiments, facial recognition may be implemented using the cameras of the UAV in association with one or more processors and memory of the UAV to determine a target for computer vision-controlled flight having 360-degree obstacle detection ensuring a safe approach to the proximity of the user. In particular, the UAV may hover at a predetermined distance away from the user.

Diagram 157 depicts UAV 156 delivering item 160 to a user, and receiving payment via a payment means 162 (e.g., credit card, cash, token, and the like). In one embodiment, payment may be confirmed via wireless communication (e.g., Bluetooth, WiFi, cellular, and the like). In another aspect, the UAV 156 may include an onboard payment component such as a point-of-sale device to provide a variety of methods to provide payment. For example, the payment component of the UAV 156 may allow for a swipe and/or tap a card or device, scan a QR code to allow for payment over cloud servers, and may feature a touch screen to allow the user to interact with the payment component.

Diagram 159 depicts UAV 156 retreating from the proximity of a user after having received payment for the item 160. In one embodiment, the UAV may be configured to facilitate a payment confirmation to the user. After payment, the item 160 may be released to the user. In particular, the payment confirmation may be received by a user device (e.g., a mobile phone) via a wireless network (e.g., Bluetooth, Wi-Fi, cellular, and/or the like).

Diagram 161 depicts UAV 156 going to another delivery or returning to a restocking area after having delivered item 160. In particular, the UAV may return to the restocking area to obtain other products. In another embodiment, the UAV may be configured to carry more than one product, as will be further described below. Further, the UAV may return to a docking site (for example, a designated area of the baseball stadium), for example, to reduce battery usage between deliveries.

As noted, embodiments of devices and systems (and their various components) described herein can employ (AI) to facilitate automating one or more features described herein (e.g., performing object recognition, determining optimal routes, picking up and delivering packages, and the like). The components can employ various AI-based schemes for carrying out various embodiments/examples disclosed herein. To provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system, environment, etc. from a set of observations as captured via events and/or data. Determinations can be employed to identify a specific context or action, or can generate a probability distribution over states, for example. The determinations can be probabilistic—that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, etc.) schemes and/or systems (e.g., support vector machines, neural networks, expert systems, Bayesian belief networks, fuzzy logic, data fusion engines, etc.) in connection with performing automatic and/or determined action in connection with the claimed subject matter. Thus, classification schemes and/or systems can be used to automatically learn and perform a number of functions, actions, and/or determinations.

A classifier can map an input attribute vector, z=(z1, z2, z3, z4, . . . , zn), to a confidence that the input belongs to a class, as by f(z)=confidence(class). Such classification can employ a probabilistic and/or statistical-based analysis (e.g., factoring into the analysis utilities and costs) to determine an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence can be employed. Classification as used herein also is inclusive of statistical regression that is utilized to develop models of priority.

FIG. 2A shows a diagram that depicts a UAV, in accordance with example embodiments of the disclosure. In particular, FIG. 2A shows a UAV 200 that may include one or more propellers 202. In another embodiment, the propellers 202 may be at least partially enclosed by a guard 204, such that the propellers 202 may not directly contact body parts of users during a delivery or in the event of a malfunction. Accordingly, the guard 204 may serve to provide a measure of security to users. In various embodiments, the UAV 200 may be coupled to one or more compartments, such as compartment 206. In one embodiment, the compartment 206 may be configured to include one or more items 212, such as food items, beverages, and the like.

In various embodiments, the UAV 200 may be coupled to a payment component 210. In another embodiment, the payment component 210 may include a POS system. As noted, the payment component may include, for example, an electronic funds transfer at point of sale (EFTPOS) device. The EFTPOS device may be capable of executing a transaction (e.g., an electronic fund transaction) using one or more of a magnetic strip, chip, and near field communication (NFC) device. In another embodiment, a wireless communication device can allow for the payment component to receive payment confirmations. In another aspect, the UAV 200 may allow for a swipe and/or tap a card or device, scan a QR code to allow for payment over cloud servers, and may feature a touch screen to allow the user to interact with the payment component. In one embodiment, if payment is confirmed via the payment component of the UAV 200, compartment 206 may dispense the item to the user.

In one aspect, the UAV 200 may include sensors 203 for sensing or identifying objects or surfaces in an environment near the UAV 200. In one embodiment, the sensors may be used to obtain or detect identifying information on a package 212 or payload. For example, the sensors may include an optical sensor or tag reader configured to read identifying information from the tag or barcode. Example sensors may include a camera, RFID tag reader, laser barcode scanner, lidar sensors, radar sensors, image sensors, combinations thereof, and/or the like.

In one aspect, the UAV 200 may include an identification component 205 that is configured to identify one or more potential items for delivery to a user. In particular, the identification component may include, but not be limited to, one or more of a radio frequency identification (RFID) module, a barcode/QR code reader module, combinations thereof, and/or the like. For example, the sensors may scan/image each item or payload they encounter and the identification component may identify each scanned/imaged item or payload based on the sensor data. In one embodiment, the identification component may identify an item or payload by determining a serial number or other identifier corresponding to the item or payload. For example, a tag or barcode may be read to determine the identity of a payload. In one embodiment, the UAV may receive instructions to deliver a specific item and the identification component may identify items until a match for the specific item is found.

Based on the identity, or identifying information, the identification component may determine one or more characteristics for the item or payload. In one embodiment, the identification component may determine a serial number or unique identifier for an item and then query, via a radio, a database for characteristics or requirements for the item. The identification component may determine one or more dimensions of an item. The dimensions may be needed to allow the forklift system to accommodate and/or hold the item. The identification component may identify a delivery location based on an identity of the payload. The delivery location may include an address, GPS location, or the like. The delivery location may include enough information to allow the UAV 200 to fly to and deliver the item.

In one aspect, the UAV 200 may include a size component that is configured to determine a dimension of the payload. For example, the size component may determine a vertical height, horizontal height, or depth of the item. The size component may determine the dimension based on data gathered by the identification component or may determine the size based on a camera image or other data. The size component may also determine a weight or other information about the item relative to delivery.

The UAV 200 may optionally include mission instruments such as a camera, microphones, equipment fastener hooks, at least one screen, sounding balloons, or small pieces of equipment specific to a destination. According to another aspect, the UAV 200 may be fitted with measuring equipment, e.g., in order to take samples of the atmosphere so as to detect signs of pollution.

In one embodiment, the UAV 200 may scan one or more packages using a sensor that can read a quick response (QR) code, bar code, text, or the like to identify a package. For example, the UAV may include a camera or other optical sensor. In one embodiment, the UAV may scan the one or more packages using another type of reader such as a radio-frequency identification (RFID) tag reader to read RFID tags on the products.

In various aspects, based on the identity of the package, box, or payload, the UAV 200 may determine metadata about the package. For example, the information read from the tag or code may include the metadata or may include a key to look up the metadata in a database or table. The metadata for the package, box, or payload may include a height of the package, a delivery destination (e.g., GPS or address information), or the like.

FIG. 2B shows a diagram of a compartment component that may be used in connection with a UAV, in accordance with example embodiments of the disclosure. In particular, compartment component 201 may include a guard 202 including one or more items 212, such as one or more food items (e.g., chips). In another embodiment, the compartment component 201 may include a motor 207 that may be configured to turn a spiral coil 208. In another embodiment, when a payment is made to the payment component of the UAV (e.g., when a predetermined number of coins have been inserted into a coin acceptance mechanism of the UAV or when a credit card is swiped at a POS system of a UAV), the motor 207 may rotate the spiral coil 208. As the spiral coil 208 rotates, the items 212 being vended may be advanced from the free end of the coil on which the items 212 are supported toward the fixed end 205 of the spiral coil 208. In various embodiments, the spiral coil 208 may be made of a continuous series of interconnected loops, usually substantially circular, with the loops remote from the coin-operated mechanism being spaced apart by a distance sufficiently close so that the items 212 may be supportably held in the spiral. When, however, the items 212 reach the loops at the fixed end 205 of the spiral coil 208, which are spaced by a distance sufficiently far apart so that the coil no longer provides support for the items, gravity may cause the items 212 to fall through the space between neighboring loops onto a dispensing chute (not shown) where they can be accessed by a user.

FIG. 3 represents a diagram showing a set of components associated with a UAV, according to various embodiments of the disclosure. In particular, the UAV or drone may include a power supply 305 (e.g., battery), a memory 310 (e.g., volatile memory and/or nonvolatile memory), processor(s) 315 for executing instructions and performing calculations, sensors 320, navigation system 325, communication system 330, image processing module 335, inertial measurement unit (IMU) 340, global positioning system (GPS) 345, package evaluation module 350, and fingerprint reader 355.

In one embodiment, the communication system 330 may also include one or more communications interfaces for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the communication system 330 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Zigbee, Bluetooth protocols, wireless universal serial bus (USB) protocols, and/or any other wireless protocol.

Processor(s) 315 are the main processors of drones which may include application processors, various coprocessors, and other dedicated processors for operating drones. Processor(s) 315 may be communicably coupled with memory 310 and configured to run the operating system, user interfaces, sensors 320, navigation system 325, communication system 330, image processing module 335, and/or other components. In some embodiments, processor(s) 315 may include multiple dedicated or shared processors configured to perform signal processing (e.g. baseband processors for cellular communications), implement/manage real-time radio transmission operations of the drone, make navigation decisions (e.g., compute flight paths, implement obstacle avoidance routines, etc.). These processors along with the other components may be powered by power supply 305. The volatile and nonvolatile memories found in various embodiments may include storage media for storing information such as processor-readable instructions, data structures, program modules, or other data. Some examples of information that may be stored include basic input/output systems (BIOS), operating systems, and applications.

Sensors 320 may be used to detect events or changes in the surrounding environment and produce a corresponding signal that can be acted upon by various components within the delivery drone or transmitted to other parts of the drone delivery infrastructure. In some embodiments, sensors 320 may include one or more of the following: a microphone, a camera, a thermostat, an accelerometer, light sensors, motion sensors, moisture sensors, fingerprint readers, retinal scanners, chemical sensors, scales, LIDAR, RADAR, and the like. Several of these sensors, for example, may be used as part of the navigation system 325. As another example, battery life can vary significantly based on temperature. As such, the temperature reading from the thermostat may be used to more accurately predict the range of the delivery drone. In some embodiments, the signal generated by the microphone can be used to determine the noise level of the surrounding environment and to record a voice message or identification from a user inserting or removing a package. Still yet, sensors 320 may include credit card readers for accepting payments, including Bluetooth or near field communication (NFC) systems.

The navigation system 325 can be responsible for determining the flight path of delivery drone. In some embodiments, high-level instructions or pick-up/drop-off destinations can be communicated to the drone via the communication system 330. The navigation system 325 may receive inputs from multiple sensors 320 (e.g., accelerometers, gyroscopes, LIDAR, RADAR, etc.), image processing module 335, inertial measurement unit (IMU) 340, and/or GPS 345 to determine optimal flight paths, detect and avoid objects, coordinate with other nearby drones using the communication system 330, and the like. For example, IMU 340 can determine the delivery drone's orientation and velocity.

According to one embodiment, the navigation system 325 may include location determining aspects, devices, modules, functionalities, and/or similar words used herein interchangeably. For example, the navigation system 325 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information can be determined by triangulating the drone's position in connection with a variety of other systems, including cellular towers, Wi-Fi access points, and/or the like. Similarly, the navigation system 325 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (for example smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

As noted, FIG. 3 illustrates a set of components within a delivery UAV. In one embodiment, packages may refer to one or more items. In another aspect, the drone may include a package evaluation module 350 that can use input from sensors 320, image processing module 335, and/or fingerprint reader 355 to determine whether to deliver the package to the user. For example, package evaluation module 350 may request user authentication via areader 355 (e.g., fingerprint reader) and/or another biometric reader. If the reading does not match the record on file (e.g., from an initial registration with the delivery system or other third-party servers), then the package evaluation module 350 may determine to not deliver the item(s). As another example, a scale may be used to measure the weight of the package. If the package evaluation module 350 determines that the package exceeds a maximum weight for the delivery drone, then the package may not be picked up for delivery.

In various embodiments, the package evaluation module 350 may use the image processing module 335 to identify the size and/or type of package, verify the identity of a package and/or item that the user is requesting for delivery, various types of chemical sensors to detect possible explosives, barcode readers to identify an originator/packer, as well as others. In some embodiments, the package analysis governed by package evaluation module 350 could be a combination of: X-Ray of packages and/or chemical sensors to ensure hazardous packages are not sent. In some embodiments, the delivery drones may also include a display (e.g., a liquid crystal display) or interface with a mobile device (e.g., via a personal area network, Bluetooth, cellular network, etc.) to confirm with the user that no hazardous packages (e.g., listed on the display) are included in the shipment. If no confirmation is received, the package evaluation module 350 may refuse the delivery.

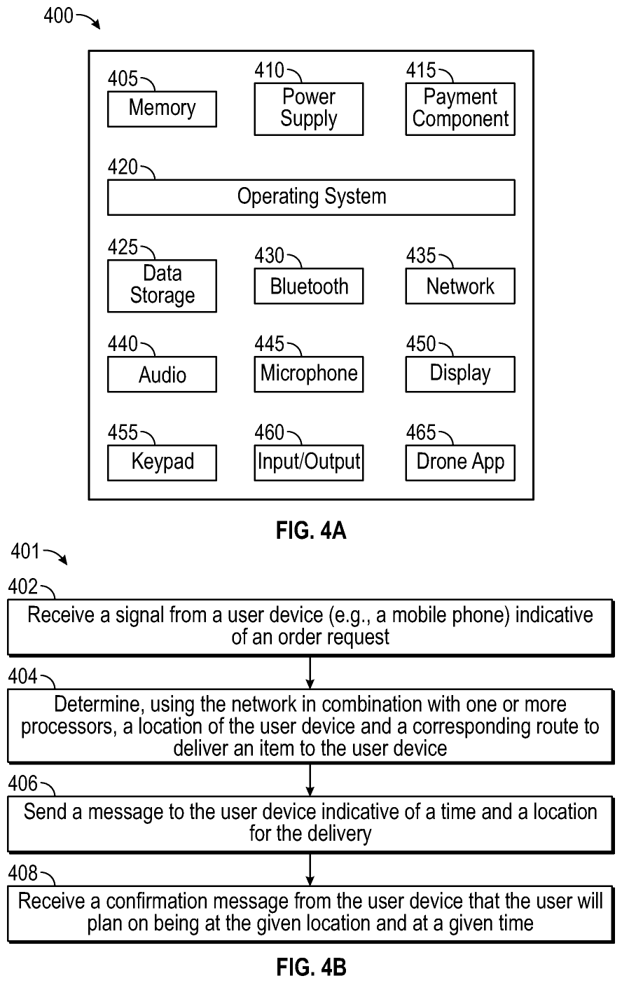

FIG. 4A illustrates a set of components within a mobile device with a drone application according to various embodiments of the disclosure. The mobile device 400 may include a drone application 465 that may be used in connection with a management component of a UAV to configure aspects of the UAVs in association with the aerial components, winches, and/or ground components described above. As shown in FIG. 4A, mobile device 400 may include memory 405 (e.g., volatile memory and/or nonvolatile memory), power supply 410 (e.g., battery), processor(s) (not shown) for executing processing instructions, payment component 415, and operating system 420. Additional components such as data storage component 425 (e.g., hard drive, flash memory, memory card, etc.), one or more network interfaces (e.g., Bluetooth Interface 430; and network communication interface 435, which enables the mobile phone to communicate by transmitting and receiving wireless signals using licensed, semi-licensed or unlicensed spectra over a telecommunications network), audio interface 440, microphone 445, display 450, keypad or keyboard 455, and other input and/or output interfaces 460 (e.g. a fingerprint reader or other biometric sensor/security feature). The various components of a mobile device may be interconnected via a bus.

In various embodiments, the payment component 415 may be configured to operate with an EFTPOS device. The EFTPOS device may be capable of executing a transaction (e.g., an electronic fund transaction) using one or more of a magnetic strip, chip, and NFC device. In another embodiment, a wireless communication device can allow for the payment component to receive payment confirmations. In one embodiment, if payment is confirmed via the payment component of the UAV, the cargo compartment may dispense the item to a user. In another aspect, the UAV may include an onboard payment component such as a point-of-sale device to provide a variety of methods to provide payment. For example, the payment component of the UAV may allow for a swipe and/or tap a card or device, scan a QR code to allow for payment over cloud servers, and may feature a touch screen to allow the user to interact with the payment component.

Processor(s) (not shown) are the main processors of mobile device 400, and they may include application processors, baseband processors, various coprocessors, and other dedicated processors for operating mobile device 400. For example, an application processor can provide the processing power to support software applications, memory management, graphics processing, and multimedia. An application processor may be communicably coupled with memory 405 and configured to run the operating system, the user interface, and the applications stored on memory 405 or data storage component 425. A baseband processor may be configured to perform signal processing and implement/manage real-time radio transmission operations of mobile device 400. These processors along with the other components may be powered by power supply 410. The volatile and nonvolatile memories found in various embodiments may include storage media for storing information such as processor-readable instructions, data structures, program modules, or other data. Some examples of information that may be stored include basic input/output systems (BIOS), operating systems, and applications.

In accordance with some embodiments, the drone application 465 may be installed on mobile device 400. Drone application 465 may be used to register a user, confirm pick-up/drop-off locations and/or times, convey the current location of a delivery drone, provide real-time video or images from a delivery done, reschedule pick-up/drop-off times/locations, and the like.

FIG. 4B shows a diagram of a process flow for item delivery, in accordance with example embodiments of the disclosure. At block 402 of process 401, the drone application 465 may be configured to receive a signal from a user device (e.g., a mobile phone) indicative of an order request. At block 404, the drone application 465 may determine, using the network 435 in combination with one or more processors (not shown), a location of the user device and a corresponding route to deliver an item to the user device. In particular, the drone application 465 may already have scheduled previous deliveries to additional users, and may therefore need to schedule the current delivery request along a partially determined route, which may need to be updated accordingly using any suitable technique (e.g., an AI-based algorithm for route optimization). At block 406, the drone application 465 may send a message to the user device indicative of a time and a location for the delivery. In one embodiment, the time and location may be based at least in part on the determination made at block 404. At block 408, the drone application 465 may be configured to receive a confirmation message from the user device that the user will plan on being at the given location and at a given time, with a given duration before the drone is to refund the user and not make a delivery (e.g., within 30 seconds to 1 minute).

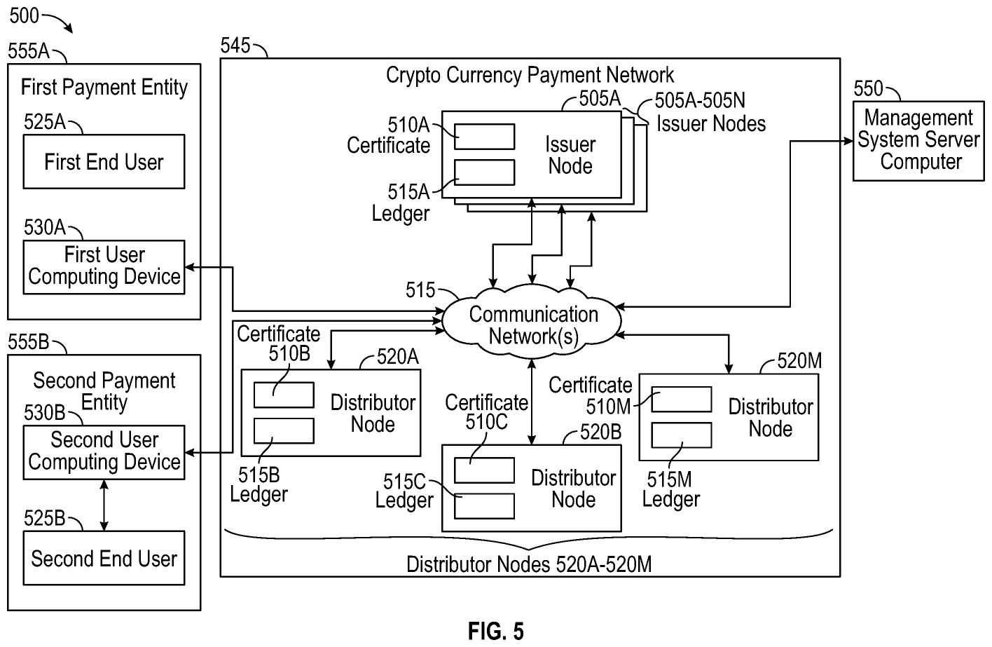

In another aspect, FIG. 5 shows a block diagram of an exemplary system including a cryptocurrency payment network that may be used for payments for items delivered by the UAVs, in accordance with example embodiments of the disclosure. In particular, the cryptocurrency payment network may be used by the UAV and/or any associated component, for example, a payment component of the UAV to provide cryptocurrency and/or token-based purchases for users without revealing the user's sensitive identity information. In particular, the cryptocurrency payment network may be used by the UAV and/or any associated component to for a version of digital cash-like payment for users. In some embodiments, system 500 in FIG. 5 includes a cryptocurrency payment network 545 that may be connected to a peer-to-peer network that may include a first payment entity 555A comprising a first end user 525A with a first user computing device 530A, a second payment entity 555B comprising a second end user 525B with a second user computing device 530B, one or more issuer nodes 505A-505N, one or more distributor nodes 520A-520M, and a management system server computer 550. In some embodiments, the first end user 525A and the second end user 525B may be one of an individual user, a business entity, and an organization. Accordingly, the first end user 525A may represent a user that interacts with the UAV to provide payment for an item, while the second end user 525B may be a provider of the UAV services and/or items for sale. In another embodiment, the first end user 525A and the second end user 525B may not be in direct communication and may not need to further verify payment credentials based at least in part on the fact that system 500 does not require such information to process payment. Each of these systems and computers may be in operative communication with each other via any suitable communication medium (including the Internet), using any suitable communications protocol.

Various terms used throughout the specification and/or claims are defined below. In particular, in an embodiment, “blockchain” or “blockchain” may refer to a distributed database that keeps a growing list of data records. In another embodiment, each data record may be protected against tampering and revisions. Blockchains may be used in association with public ledgers of transactions, and the record may be protected cryptographically.

In another embodiment, “computing node” may refer to a computational device with an internal address that can host a copy of a blockchain and the associated transactions, for example, as a part of a peer-to-peer network.

In one embodiment, a “hash function” may refer to a mathematical algorithm that may map an arbitrarily-large amount of data into a fixed-length size. In one embodiment, a given hash will always result from the same data, but modifying the data (e.g., changing a bit of the data) may change the hash. The values returned by the hash function are called a “hash”.

In one embodiment, “public ledger” may refer to a publicly accessible listing of transactions for the distributed database or blockchain.

In another embodiment, “digital currency” may refer to units of value that may be used as a form of payment for transactions, including financial transactions. Digital currency may include currency that is electronically generated by and stored within a computing device. Digital currency may be purchased using conventional forms of currency (e.g., fiat currency such as dollars or Euros) and generated with a specific value. Typically, the digital currency may not have a physical form of tender but may be accessible through a user computing device (e.g., mobile device) using a software application such as a digital wallet or mobile application.

In one embodiment, a “cryptocurrency payment network” may refer to one or more server computers that function to operate and maintain a cryptocurrency system. The cryptocurrency payment network may function to facilitate the generation/issuance and distribution of digital currency between the one or more server computers within the cryptocurrency payment network. The cryptocurrency payment network may also function to enable the performance of transactions between the server computers for the transfer of goods/services and/or the transfer of funds.

In the context of cryptocurrency systems, the term “node” may refer to a computing device within the cryptocurrency system. A node in a cryptocurrency system may be associated with and/or operated by a financial institution server computer of a financial institution (e.g., bank). Each node may have particular rights and restrictions associated with the node. For example, an issuer node may have the right to generate and issue digital currency within a cryptocurrency payment network, while a distributor node may have the right to distribute digital currency, but not generate or issue digital currency. Other nodes in the cryptocurrency payment network, such as merchants and users (e.g., consumers), may have the right to transfer digital currency.

In one embodiment, a “ledger of transactions” may refer to a compilation of data from previous transactions. The ledger of transactions may be a database or other comparable file structure that may be configured to store data from all previous transactions performed using a digital currency, including the date and time of the transaction, the transaction amount, and the participants of the transaction (e.g., the sender and the receiver of the transaction amount). In some embodiments, the ledger of transactions may include at least part of a blockchain, where a new block in the blockchain is algorithmically determined based on new transactions and previous blocks in the block chain. In some embodiments, each node within a cryptocurrency payment network may store their own copy of the ledger of transactions. In other embodiments, only some nodes may store their own copy of the ledger of transactions.

In one embodiment, a “digital certificate” may refer to data used as part of a verification process. A digital certificate may be used to send information from one entity to another entity. The digital certificate may be used to verify that the entity sending a message is authentic. In some embodiments, a digital certificate may include data indicating a digital certificate version, a serial number, an algorithm identifier, a name of the issuing certificate authority (e.g., a management component), an expiration date, a copy of the node verification public key, and the digital signature of the issuing certificate authority so that a recipient (e.g., the node) can verify that the certificate is authentic.

In one embodiment, “digital signature” may refer to an electronic signature for a message. In some embodiments, the digital signature may be used to validate the authenticity of a transaction message sent within a cryptocurrency payment network. A digital signature may be a unique value generated from a message and a private key using an encrypting algorithm (e.g., a Rivest—Shamir—Adleman, RSA, algorithm). In some embodiments, a decrypting algorithm using a public key may be used to verify the signature. The digital signature may include, but not be limited to, a numeric value, an alphanumeric value, or any other type of data including a graphical representation.

In one embodiment, “key” may refer to a piece of data or information used for an algorithm. A key may be a unique piece of data and is typically part of a key pair where a first key (e.g., a private key) may be used to encrypt a message, while a second key (e.g., a public key) may be used to decrypt the encrypted message. The key may be a numeric or alphanumeric value and may be generated using an algorithm. A management system server computer in a cryptocurrency payment network may generate and assign a unique key pair for each node in the cryptocurrency payment network. In some embodiments, a key may refer to either a node verification key pair or a transaction key pair.

A transaction key pair may include a transaction public key and a transaction private key. The transaction key pair may be used by the nodes and/or payment entities to conduct transactions in the cryptocurrency payment network. The transaction key pair may be generated by one or more user devices (e.g., a server device, a mobile device, etc.) or may be generated by a third-party device (e.g., a financial institution server computer) for a payment entity when an account with a given financial institution server computer is created. The transaction public key of a node may be distributed throughout a cryptocurrency payment network in order to allow for authentication of payment transaction messages signed using the private key of the node.

Further, a node verification key pair may include a node verification public key and a node verification private key. The node verification key pair may be used by the nodes and the management system to verify that a node is an issuer node or a distributor node. The node verification key pair may be generated by a given device (e.g., a management system server computer) in response to a request message from a node to be designated an issuer node or a distributor node in the cryptocurrency payment network. In other embodiments, the node verification key pair may be generated by a node (e.g., a financial institution server computer) and sent to the management system server computer. In some embodiments, a node verification public key may be functionally similar to a transaction public key. However, the node verification public key may only be distributed to the node associated with the node verification public key. In such embodiments, the node verification public key may be encrypted prior to being sent to the appropriate node.

In one embodiment, an “identifier” may refer to any information that may be used to identify information. In some embodiments, the identifier may be a special value generated randomly or according to a predetermined algorithm, code, or shared secret. For example, an account identifier may be used to uniquely identify an account. In some embodiments, the identifier may be one or more graphics, a token, a bar code, a QR code, or any other information that may be used to uniquely identify an entity.

In another embodiment, a “transaction” may include an exchange or interaction between two entities. In some embodiments, a transaction may refer to a transfer of value between two users (e.g., individuals or entities). A transaction may involve the exchange of monetary funds (e.g., digital currency), or the exchange of goods or services for monetary funds between two individuals or entities. In other embodiments, the transaction may be a purchase transaction involving an individual or entity purchasing goods or services from a merchant or other entity in exchange for monetary funds. In other embodiments, the transaction may be a non-financial transaction, such as exchanging of data or information between two entities, such as the transfer of data or information across a communications channel. Examples of non-financial transactions may include transactions for verifying an identity of a server computer and/or rights and restrictions associated with the server computer.

In one embodiment, a “message” may include any data or information that may be transported from one entity to another entity (e.g., one computing device to another computing device). Messages may be communicated internally between devices/components within a computer or computing system or externally between devices over a communications network. Additionally, messages may be modified, altered, or otherwise changed to comprise encrypted or anonymized information.

In the embodiment shown in FIG. 5, the systems and computers are shown to interact via one or more communication networks 515 (e.g., one or more of the Internet, private communication networks, and public communication networks). In some aspects, an example number of components are shown in system 500. It is understood, however, that embodiments of the disclosure may include more than one of each component. In addition, some embodiments of the disclosure may include fewer than or greater than all of the components shown in FIG. 5. In another embodiment, the inclusion of dotted lines indicates optional features that indicate that the number of these entities included in various embodiments may be different. Similarly, the use of “N” and “M” when referring to the issuer nodes 505A-505N and distributor nodes 520A-520M indicates that there may be any number of these entities in various embodiments, and further that there need not be the same number of issuer nodes 505A-505N and distributor nodes 520A-520M in various cryptocurrency payment network 545 configurations. In another embodiment, the user computing devices 530A-530B may be in any suitable form. For example, suitable user computing devices may be hand-held and compact so that they can fit into a user's pocket. Examples of user computing devices 530A-530B may include any device capable of accessing the Internet. Specific examples of user computing devices 530A-530B include cellular or wireless phones (e.g., smartphones), tablet phones, tablet computers, laptop computers, desktop computers, terminal computers, work stations, personal digital assistants (PDAs), physical cryptocurrency wallet hardware, pagers, portable computers, smart cards, and the like. In some embodiments of the disclosure, the user computing devices 530A-530B and a payment device associated with the user may be a single device (e.g., a mobile phone).

The user computing devices 530A-530B may include a processor and a computer readable medium coupled to the processor, the computer readable medium comprising code, executable by the processor for performing the functionality described herein. The user computing devices 530A-530B may transmit data through the communication networks 515 to issuer nodes 505A-505N, distributor nodes 520A-520M, and to the other user computing devices 530A-530B. For example, the first user computing device 530A may represent a client's device be communicatively coupled to the second user computing device 530B via the communication networks 515 to conduct a transaction with a provider (e.g., a service provider) associated with the second user computing device 530B.

In some embodiments, the cryptocurrency payment network 545 may comprise one or more server computers (not illustrated) implementing the issuer nodes 505A-505N and the distributor nodes 520A-520M. In some embodiments, each issuer node 505A-505N and distributor node 520A-520M may be a server computer associated with a separate financial institution. For example, each issuer node 505A-505N may be associated with a central bank, federal reserve, or government authority, while each distributor node 520A-520M may be associated with a different commercial bank. In various embodiments, each issuer node and/or distributor node may be implemented by a separate computing device (e.g., server computer). However, in some embodiments, a single server computer may implement multiple issuer nodes and/or distributor nodes. The issuer nodes 505A-505N and the distributor nodes 520A-520M may include a processor and a computer readable medium coupled to the processor, the computer readable medium comprising code, executable by the processor for performing the functionality described herein.

In some embodiments, each of the distributor nodes 520A-520M may be implemented by one or more server computers that maintain user profiles and/or account data (e.g., financial account data) for one or more of the end users 525A-525B. For example, in some embodiments, each of the distributor nodes 520A-520M is hosted by a respective financial institution (e.g., a bank), and thus each distributor node 520A-520M may have an explicit relationship with one or more of the end users 525A-525B through a financial account, where the end user may have provided information to the financial institution (e.g., name, address, phone number, demographic information, government identification data such as a Social Security Number (SSN), etc.).

As noted above, the cryptocurrency payment network 545 may be comprised of issuer nodes 505A-505N and distributor nodes 520A-520M in communications via the communications network 515. In some embodiments, each of these nodes may be granted the rights and ability to participate in the cryptocurrency payment network 545 by the management system server computer 550. In such embodiments, the management system server computer 550 may be configured to generate and distribute digital certificates, including a node verification public key, to each of the nodes to allow the nodes to function in the cryptocurrency payment network 545. The node verification public key may be part of a node verification key pair, which may include a node verification private key. The node verification key pair may be an asymmetric key pair such that the node verification public key may be used to encrypt a message sent from a node to the management system server computer 550, and the corresponding node verification private key for that node may be used by the management system server computer 550 to decrypt the message.

The node verification key pair may be generated by a management system server computer 550 in response to a request message from a node to be designated an issuer node or a distributor node in the cryptocurrency payment network 545. In other embodiments, the node verification key pair may be generated by a node and sent to the management system server computer 550. In some embodiments, node verification public keys may be sent to the issuer nodes 505A-505N and distributor nodes 520A-520M by encrypting each of the node verification public keys such that only the associated node can decrypt their node verification public key.

In some embodiments, each of the issuer nodes 505A-505N and each of the distributor nodes 520A-520M may maintain a ledger 515A-515M of the payment transactions made in the cryptocurrency payment network 545. In some embodiments, the ledgers 515A-515M may include a list of transactions with each entry including a sender address, a receiver address, and an amount of digital currency for each transaction. In some embodiments, the ledger may include a record of all transactions ever performed using the digital currency.

In some embodiments, a payment transaction may only be considered official and successfully processed when the payment transaction is recorded in (all or one or more of) the ledgers 515A-515M. Thus, in some embodiments, all payment transaction messages need to be transmitted to the nodes maintaining the ledgers 515A-515M. In some embodiments, a payment entity (e.g., 555A) transmits a payment transaction message to each of the nodes maintaining a ledger, but in other embodiments the payment entity 555A may transmit the payment transaction message to just one of these nodes (which in turn forwards it to the other ledger-maintaining nodes) or to another computing device specially configured to provide payment transaction messages to the ledger-maintaining nodes. In some embodiments, only a subset of the nodes may maintain a ledger (e.g., only distributor node 520B) or entirely different entities altogether may maintain the ledger.

The nodes and payment entities within the cryptocurrency payment network 545 may use a digital signature for performing transactions (e.g., transferring digital currency), which is based upon the use of a digital certificate. A digital certificate, in embodiments of the disclosure, may utilize a transaction key pair (e.g., a transaction public key and a transaction private key). In some embodiments, each node can use the transaction private key to generate a digital signature (and thus, a payment message), and the node's transaction public key can be made publicly available (e.g., to other nodes in the cryptocurrency payment network 545) to allow other nodes to verify the authenticity of the payment transaction, and correspondingly record the payment transaction in their respective ledgers. In some embodiments, the transaction public key may be a “destination address” identifying a recipient of a digital currency payment.

For example, when a first payment entity 555A wishes to send digital currency to a second payment entity 555B, the first payment entity 555A generates a digital signature by: (1) creating a payment message identifying some digital currency held by the first payment entity 555A and also identifying the recipient of the funds (e.g., using a transaction public key of the second payment entity 555B), (2) encrypting the payment message using the transaction private key of the first payment entity 555A, (3) and sending the encrypted payment message to the second payment entity 555B and to the other nodes in the cryptocurrency payment network 545. The other entities (e.g., nodes, payment entities, etc.) in the cryptocurrency payment network 545 may then use the transaction public key of the first payment entity 555A to verify that the amount of digital currency is valid and has been transferred to the second payment entity 555B by the first payment entity 555A. Once the transaction is verified, the transaction may be published into ledgers (e.g., ledger 515A-515M) maintained by the one or more nodes in the cryptocurrency payment network 545.

In some embodiments, an issuer node 505A may be granted a digital certificate (e.g., 510A) by the management system server computer 550. The issuer node 505A can use this digital certificate to initiate the process of generating digital currency. There are a variety of ways to generate additional digital currency, including but not limited to the issuer node 505A creating a new payment transaction to itself, and creating new payment transactions to any of the distributor nodes 520A-520M, etc. In some embodiments, these payment transactions reference completely new currency that has not previously existed until that payment transaction—the issuer nodes 505 are able to generate or invent new digital currency simply by the authority granted to it by the management system server computer 550. Embodiments of the disclosure allow for the use of many different types of digital certificates and cryptographic algorithms known to those of skill in the art, including but not limited to the use of elliptic curve digital signature algorithm (ECDSA), the secure hash algorithm (SHA) family of cryptographic hash functions (e.g., SHA-1 family, SHA-2 family, SHA-3 family, etc.), the Scrypt algorithm, etc.

In some embodiments, a distributor node 520A may also be granted a digital certificate (e.g., 510B) by the management system server computer 550. The distributor node 520A can use this digital certificate, after receiving an amount of digital currency from an issuer node 505A, to distribute an amount of the of the digital currency to one of the payment entities (e.g., 555A, 555B) or to another distributor node (e.g., 520B-520M). For example, the distributor node 520A can create a new payment transaction to the first payment entity 555A by generating a digital signature by: (1) creating a payment message identifying some of the received digital currency held by the distributor node 520A and also identifying the recipient of the funds (e.g., using a transaction public key or destination address of the first payment entity 555A), (2) encrypting the payment message using the transaction private key of the distributor node 520A, (3) and sending the encrypted payment message to the first payment entity 555A and to the other nodes in the cryptocurrency payment network 545. Other entities (e.g., nodes, payment entities, etc.) in the cryptocurrency payment network 545 may then use the transaction public key of the first payment entity 555A to verify that the amount of digital currency is valid and has been transferred to the second payment entity 555B by the distributor node 520A. Once the transaction is verified, the transaction may be published into ledgers (e.g., ledger 515A-515M) maintained by the one or more nodes in the cryptocurrency payment network 545.

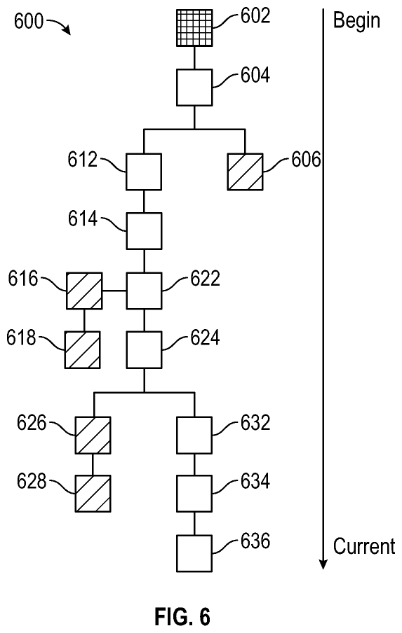

FIG. 6 is a diagram 600 illustrating an example blockchain, in accordance with example embodiments of the disclosure. Further, the blockchain may be used to securely conduct payments for items delivered by the UAVs described herein. In another aspect, the blockchain may be implemented via a blockchain protocol on a peer-to-peer network, such as the cryptocurrency payment network described above in connection with FIG. 5. Blocks in the main chain 602, 604, 612, 614, 622, 624, 632, 634, 636 may comprise the longest series of blocks that go from the beginning block 602 to the current block 636. For any block in the blockchain, there may only be one path from the beginning block 602 to the current block 636. Blocks 606, 616, 618, 626, 628 include blocks that are not in the longest chain. In another embodiment, the system may be a distributed system, such that blocks 616, 618, 626, 628 may be created only a few seconds apart from the main chain. In another embodiment, whenever a fork happens, generating computing nodes build onto which ever block is received first in time. Therefore, the short chain of blocks 616, 618, 626, 628 may not be used. In another example, each user of the blockchain in FIG. 6 may be a member. In another embodiment, after a set number of members vote on the addition of a new block in the block chain, may a block chain be added. In this member-based system, the short chains of block 616, 618, 626, 628 may not be created.

In another embodiment, the blockchain may include two kinds of records: transactions and blocks. Transactions may refer to the actual data stored in the blockchain. In another embodiment, the data in each of the blockchain may be encrypted. In one example, the data in each block may represent a single transaction. In another example, data in each block may represent more than one transaction that is dividable into sections within each block, such as, an image in series of images. Transactions are created by users or participants using the system. The blocks are recorded that confirm when and in what sequence certain transactions become journaled as back of the blockchain database.

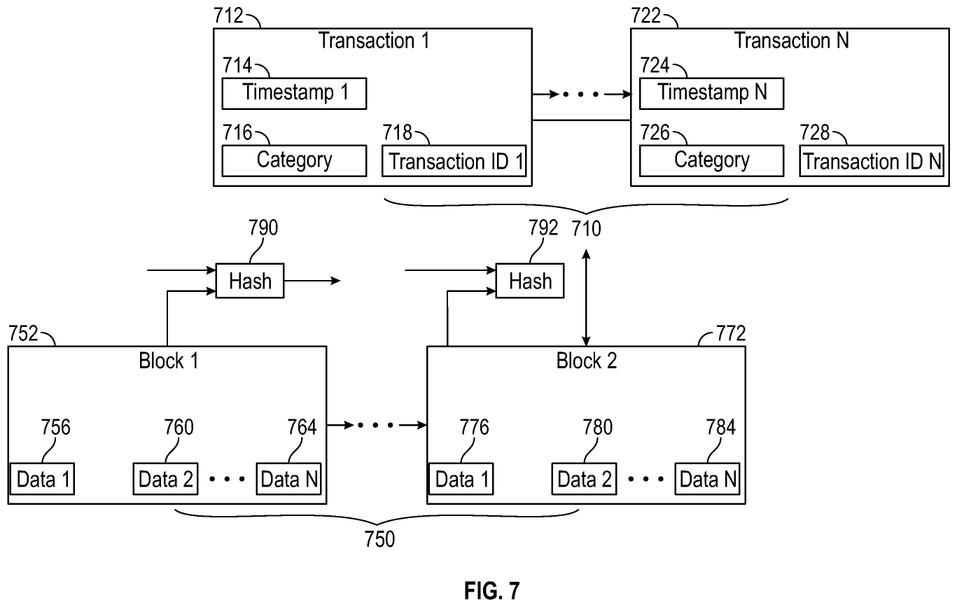

FIG. 7 shows a functional diagram 700 illustrating details of each block and transaction in a blockchain, in accordance with example embodiments of the disclosure. In particular, the diagram 700 shows two kinds of record blocks 710 and transactions 750. The transactions 750 may include data stored in the blockchain. The blocks 710 include records of transactions. In this example, transactions 750 may be associated with block 2 772, while other transactions (not shown) may be associated with block 1 752.

In various aspects, record blocks 710 may represent a series of transactions 712 through 722 as shown for transactions 1 through transaction N, respectively. In another embodiment, a given record block 710 may represent a transaction and may include a timestamp (e.g., timestamp 714 or timestamp 724) of the transaction and a unique transaction identifier (e.g., transaction identifier 1 718 and transaction identifier N 728. In one embodiment, the transaction identifier can be searched for a specific item in the transactional database management system. Also shown is an optional category for the transaction 716, such as photo, medical, financial, employment, and the like to associate with the additional data in the transactions 750 described below.

In one embodiment, a hash function 790 and 792 is shown as part of the record blocks 710. In one implementation of a blockchain, the previously hash function 790 may be input to a subsequent hash function 792, along with the transaction 1 as shown. This may ensure that there has been no tampering or alteration of the data in the record blockchain. Transactions 750 shown in block 1 through block N, (752, 772) may contain user or additional data 756, 760, 764, 776, 780, 784. The additional data can represent any suitable type of data including text, audio, video, images, financial statements, and more.

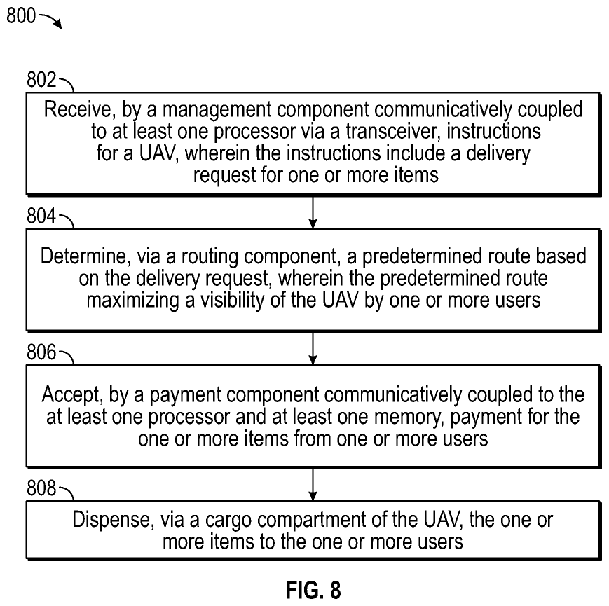

FIG. 8 shows a diagram of a process flow for item delivery using UAVs, in accordance with example embodiments of the disclosure. At block 802, the process 800 includes receiving, by a management component communicatively coupled to at least one processor via a transceiver, instructions for a UAV, wherein the instructions include a delivery request for one or more items. In one embodiment, the management component may include a drone application (similar, but not necessarily identical to, the drone application 465 as shown and described in connection with FIG. 4A above). In one embodiment, a user may provide instructions to a UAV indicative of a delivery order, using a mobile application on a user device (e.g., a mobile phone). In particular, the application may be configured to transmit a signal to a transceiver of a nearby UAV (e.g., a UAV within a predetermined distance from the user device) to approach the user and to land/hover in order to allow the user to purchase and receive the item. The UAV may include a management component that is configured to receive the instructions. In particular, the UAV may receive the signal from the user device (e.g., a mobile phone) using one or more as part of the UAV's communication system (e.g., similar, but not necessarily identical to, the UAV communication system 330 shown and described in connection with FIG. 3, above).

In various embodiments, the UAVs may be configured to display items and/or ads about such items, or may be configured to transmit information to user devices (e.g., user devices that are proximate to the UAVs) indicative of purchasable items. For example, the UAV may be configured to display information related to items on a display similar, but not necessarily identical to, display 450 as shown and described in connection with FIG. 4A, above. This display of information and/or advertisements (including, but not limited to, the display of information on the UAV itself or one or more user devices) may encourage users to buy the items. In one embodiment, the environment in which the UAV is in (e.g., a stadium or a concert) may be configured to display information received from the UAV or other third-party devices, the information indicative of purchasable items from the UAV(s) proximate to the environment. For example, a baseball stadium may display advertisements and/or other information associated with the UAVs that may inform users in the stadium to order concessions using the UAVs. In one embodiment, the UAVs may be loaded with items having a high likelihood of purchase, for example, as determined by numerous factors, individually or in combination, such as historical data, current trending data, social media posts, one or more user profiles, and the like. Further, one or more machine learning (ML) algorithms may be used to process the said data and determine which items have a higher likelihood of being purchased.

At block 804, the process 800 includes determining, via a routing component, a predetermined route based on the delivery request, wherein the predetermined route maximizing a visibility of the UAV by one or more users. In particular, the routing component may be part of the drone application 465, as shown and described in connection with FIG. 4A, above. In one embodiment, a type of the one or more items may be determined based on at least one of a location of the one or more users, an event within a distance of the predetermined route of the UAV, or preference data associated with the one or more users. In another embodiment, the management component may determine second instructions to cause the UAV to transport the one or more items on the predetermined route.

Further, the UAVs may be directed to populated regions, where the UAVs may be configured to fly in predetermined routes that seek to maximize visible coverage to potential users (e.g., customers). In another embodiment, the users may use a user device (e.g., a mobile phone) to call for a UAV (e.g., a UAV that the users see or detect via their user device) and then, the users may purchase items that the UAV is transporting.

At block 806, the process 800 includes accepting, by a payment component communicatively coupled to the at least one processor and at least one memory, payment for the one or more items from one or more users. In particular, the payment component may be similar, but not necessarily identical to, payment component 415 shown and described in connection with FIG. 4A, above. In one embodiment, at least one display may be caused to show information associated with the payment to the one or more users. In another embodiment, the UAV may have a cargo component may that be lockable and may be unlocked after the user makes a purchase of an item. In another embodiment, the UAV may include an interface (e.g., a touch screen) to enable user interaction. Further, the UAV may include a payment component, for example, an EFTPOS device. The EFTPOS device may be capable of executing a transaction (e.g., an electronic fund transaction) using one or more of a magnetic strip, chip, and near field communication (NFC) device. In another embodiment, a wireless communication device can allow for the payment component to receive payment confirmations.

At block 808, if payment is confirmed via the payment component of the UAV, the cargo compartment may dispense the one or more item to the one or more users. In various embodiments, a single UAV may be equipped with multiple cargo compartments for carrying a range of items (e.g., commonly purchased items). In another embodiment, this may reduce the number of UAVs needed to serve an area without compromising inventory options. In another embodiment, when a UAV sells out of a given item or a given type of item, the UAV may return to the restocking area; otherwise, the UAV may be configured to continue to scan for additional potential customers.

In another embodiment, one or more UAVs may be geo-locked to a particular event location or UAV service area within an event location for a given duration of time. In another embodiment, if the UAV exits the region of the geo-lock, the UAV may alert an alarm to one or more entities (e.g., law enforcement, companies, security services, insurance companies, combinations thereof, and/or the like).

In various embodiments, the UAV may hold one type of product (e.g., food items such as chips of a particular brand, or beverages of a particular type). In another embodiment, the UAV may hold a plurality of items of different types (e.g., a food item, a personal hygiene item, a clothing item, and the like).

In another embodiment, if one or more UAVs are stolen or damaged, one or more security components including, but not limited to, sirens, dye bombs, and/or cloud-enabled cameras that may record the scene of the crime may be engaged. Such devices may provide additional theft/vandalism deterrence and may further provide a means to identify transgressors. In one embodiment, the security components (e.g., sirens, dye bombs, and the like) may be triggered to activate if the UAV travels more than a predetermined distance from a landmark (e.g., an event center, a stadium, a food truck location, and/or the like).

One or more operations of the methods, process flows, and use cases of FIGS. 1-8 may be performed by one or more engines, program module(s), applications, or the like executable on an electronic device. It should be appreciated, however, that such operations may be implemented in connection with numerous other device configurations.

The operations described and depicted in the illustrative methods and process flows of FIGS. 1-8 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 1-8 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

### EXAMPLE EMBODIMENTS

Example embodiments of the disclosure may include one or more of the following examples:

Example 1 may include an unmanned aerial vehicle (UAV), comprising: a transceiver; at least one memory that stores computer-executable instructions; and at least one processor of the one or more processors configured to access the at least one memory wherein the at least one processor of the one or more processors is configured to execute the computer-executable instructions to: receive, by a management component communicatively coupled to the at least one processor via the transceiver, instructions for the UAV, wherein the instructions include a delivery request for one or more items; determine, via a routing component, a predetermined route based on the delivery request, wherein the predetermined route maximizing a visibility of the UAV by one or more users; and accept, by a payment component communicatively coupled to the at least one processor and the at least one memory, payment for the one or more items from one or more users.

Example 2 may include the UAV of example 1, wherein the payment includes a token or a cryptocurrency.

Example 3 may include the UAV of example 1 and/or some other example herein, wherein the one or more items include at least one of a first food item of a first type or a second food item of a second type.

Example 4 may include the UAV of example 1 and/or some other example herein, wherein the UAV comprises one or more propellers and a guard to at least partially enclose the one or more propellers.

Example 5 may include the UAV of example 1 and/or some other example herein, wherein the UAV includes at least one cargo component to store the one or more items.

Example 6 may include the UAV of example 1 and/or some other example herein, wherein a type of the one or more items is determined based at least on one of a location of the one or more users, an event within a distance of the predetermined route of the UAV, or preference data associated with the one or more users.

Example 7 may include the UAV of example 1 and/or some other example herein, wherein the at least one processor is further configured to execute the computer-executable instructions to: determine, via the management component, second instructions to cause the UAV to transport the one or more items on the predetermined route.

Example 8 may include the UAV of example 1 and/or some other example herein, wherein the payment component comprises an electronic funds transfer at point of sale (EFTPOS) device.

Example 9 may include the UAV of example 1 and/or some other example herein, wherein the UAV further comprises at least one display configured to show information associated with the payment to the one or more users.

Example 10 may include the UAV of example 1 and/or some other example herein, wherein the UAV further comprises a security mechanism configured to engage when the UAV is moved outside a predetermined radius from a location or the one or more items are stolen.

Example 11 may include a method, comprising: receiving, by a management component communicatively coupled to at least one processor via a transceiver, instructions for a UAV, wherein the instructions include a delivery request for one or more items; determining, via a routing component, a predetermined route based on the delivery request, wherein the predetermined route maximizing a visibility of the UAV by one or more users; and accepting, by a payment component communicatively coupled to the at least one processor and at least one memory, payment for the one or more items from one or more users.

Example 12 may include the method of example 11, wherein the method further comprises determining a type of the one or more items based at least on one of a location of the one or more users, an event within a distance of the predetermined route of the UAV, or preference data associated with the one or more users.

Example 13 may include the method of example 11 and/or some other example herein, wherein the method further comprises determining, by the management component, second instructions to cause the UAV to transport the one or more items on the predetermined route.

Example 14 may include the method of example 11 and/or some other example herein, wherein the method further comprises causing at least one display to show information associated with the payment to the one or more users.

Example 15 may include the method of example 11 and/or some other example herein, wherein the method further comprises causing a security mechanism to engage when the UAV is moved outside a predetermined radius from a location or the one or more items are stolen.

Example 16 may include a non-transitory computer-readable medium storing computer-executable instructions which, when executed by a processor, cause the processor to perform operations comprising: receiving, by a management component communicatively coupled to the processor via a transceiver, instructions for a UAV, wherein the instructions include a delivery request for one or more items; determining, via a routing component, a predetermined route based on the delivery request, wherein the predetermined route maximizing a visibility of the UAV by one or more users; and accepting, by a payment component communicatively coupled to the processor and at least one memory, payment for the one or more items from one or more users.

Example 17 may include the non-transitory computer-readable medium of example 16, wherein the computer-executable instructions are further configured to cause the processor to determine a type of the one or more items based at least on one of a location of the one or more users, an event within a distance of the predetermined route of the UAV, or preference data associated with the one or more users.

Example 18 may include the non-transitory computer-readable medium of example 16 and/or some other example herein, wherein the computer-executable instructions are further configured to cause the processor to determine, by the management component, second instructions to cause the UAV to transport the one or more items on the predetermined route.

Example 19 may include the non-transitory computer-readable medium of example 16 and/or some other example herein, wherein the computer-executable instructions are further configured to cause the processor to cause a display of the UAV to show information associated with the payment to the one or more users.

Example 20 may include the non-transitory computer-readable medium of example 16 and/or some other example herein, wherein the computer-executable instructions are further configured to cause the processor to cause a security mechanism configured to engage when the UAV is moved outside a predetermined radius from a location or the one or more items are stolen.

What is claimed is:

1. An unmanned aerial vehicle (UAV), comprising:
a transceiver;
at least one memory that stores computer-executable instructions; and
at least one processor of the one or more processors configured to access the at least one memory wherein the at least one processor of the one or more processors is configured to execute the computer-executable instructions to:
receive, by a management component communicatively coupled to the at least one processor via the transceiver, instructions for the UAV, wherein the instructions include a delivery request for one or more items;
determine, via a routing component, a predetermined route based on the delivery request, wherein the predetermined route maximizing a visibility of the UAV by one or more users; and
accept, by a payment component communicatively coupled to the at least one processor and the at least one memory, payment for the one or more items from one or more users.

2. The UAV of claim 1, wherein the payment includes a token or a cryptocurrency.

3. The UAV of claim 1, wherein the one or more items include at least one of a first food item of a first type or a second food item of a second type.

4. The UAV of claim 1, wherein the UAV comprises one or more propellers and a guard to at least partially enclose the one or more propellers.

5. The UAV of claim 1, wherein the UAV includes at least one cargo component to store the one or more items.

6. The UAV of claim 1, wherein a type of the one or more items is determined based at least on one of a location of the one or more users, an event within a distance of the predetermined route of the UAV, or preference data associated with the one or more users.

7. The UAV of claim 1, wherein the at least one processor is further configured to execute the computer-executable instructions to:
determine, via the management component, second instructions to cause the UAV to transport the one or more items on the predetermined route.

8. The UAV of claim 1, wherein the payment component comprises an electronic funds transfer at point of sale (EFTPOS) device.

9. The UAV of claim 1, wherein the UAV further comprises at least one display configured to show information associated with the payment to the one or more users.

10. The UAV of claim 1, wherein the UAV further comprises a security mechanism configured to engage when the UAV is moved outside a predetermined radius from a location or the one or more items are stolen.

11. A method, comprising:
receiving, by a management component communicatively coupled to at least one processor via a transceiver, instructions for a UAV, wherein the instructions include a delivery request for one or more items;
determining, via a routing component, a predetermined route based on the delivery request, wherein the predetermined route maximizing a visibility of the UAV by one or more users; and
accepting, by a payment component communicatively coupled to the at least one processor and at least one memory, payment for the one or more items from one or more users.

12. The method of claim 11, wherein the method further comprises determining a type of the one or more items based at least on one of a location of the one or more users, an event within a distance of the predetermined route of the UAV, or preference data associated with the one or more users.

13. The method of claim 11, wherein the method further comprises determining, by the management component, second instructions to cause the UAV to transport the one or more items on the predetermined route.

14. The method of claim 11, wherein the method further comprises causing at least one display to show information associated with the payment to the one or more users.

15. The method of claim 11, wherein the method further comprises causing a security mechanism to engage when the UAV is moved outside a predetermined radius from a location or the one or more items are stolen.

16. A non-transitory computer-readable medium storing computer-executable instructions which, when executed by a processor, cause the processor to perform operations comprising:
receiving, by a management component communicatively coupled to the processor via a transceiver, instructions for a UAV, wherein the instructions include a delivery request for one or more items;
determining, via a routing component, a predetermined route based on the delivery request, wherein the predetermined route maximizing a visibility of the UAV by one or more users; and
accepting, by a payment component communicatively coupled to the processor and at least one memory, payment for the one or more items from one or more users.

17. The non-transitory computer-readable medium of claim 16, wherein the computer-executable instructions are further configured to cause the processor to determine a type of the one or more items based at least on one of a location of the one or more users, an event within a distance of the predetermined route of the UAV, or preference data associated with the one or more users.

18. The non-transitory computer-readable medium of claim 16, wherein the computer-executable instructions are further configured to cause the processor to determine, by the management component, second instructions to cause the UAV to transport the one or more items on the predetermined route.

19. The non-transitory computer-readable medium of claim 16, wherein the computer-executable instructions are further configured to cause the processor to cause a display of the UAV to show information associated with the payment to the one or more users.

20. The non-transitory computer-readable medium of claim 16, wherein the computer-executable instructions are further configured to cause the processor to cause a security mechanism configured to engage when the UAV is moved outside a predetermined radius from a location or the one or more items are stolen.
